(19) United States
(12) Patent Application Publication
(10) Pub. No.: US 2024/0241310 A1
(43) Pub. Date: Jul. 18, 2024

(54) Wavelength Converter

(71) Applicant: Nippon Telegraph and Telephone Corporation, Tokyo (JP)

(72) Inventors: Nobutatsu Koshobu, Musashino-shi, Tokyo (JP); Koji Embutsu, Musashino-shi, Tokyo (JP); Takeshi Umeki, Musashino-shi, Tokyo (JP); Osamu Tadanaga, Musashino-shi, Tokyo (JP); Takushi Kazama, Musashino-shi, Tokyo (JP); Takahiro Kashiwazaki, Musashino-shi, Tokyo (JP); Asuka Inoue, Musashino-shi, Tokyo (JP); Kei Watanabe, Musashino-shi, Tokyo (JP)

(21) Appl. No.: 18/558,584

(22) PCT Filed: Jun. 2, 2021
(86) PCT No.: PCT/JP2021/021102

§ 371 Date: Nov. 2, 2023

(51) Int. Cl. G02B 6/122; G02F 1/39

(52) U.S. Cl. CPC G02B 6/1223; G02F 1/392

(57) ABSTRACT

A module structure that makes it easy to mount pigtail optical fibers by mounting a wavelength conversion apparatus, to enable adjustment of the path distance of optical signals, or to control the path distance of each individual polarization for polarization diversity control with high precision. The wavelength conversion apparatus is characterized in that when mounting a module having two or more input and output ports of a wavelength conversion apparatus, the module is configured to take out the input and output ports from two corresponding walls of the mounting housing, and also has a mechanism to control the path distance of at least one of the signal light and the excitation light input from each input and output port, and has a mechanism to separate the polarization of at least one of the signal light and the excitation light input from the ports and to control the path distance.

### TECHNICAL FIELD

The present invention relates to a wavelength conversion apparatus, and more particularly to a mounting structure of a wavelength conversion element of a wavelength conversion apparatus.

### BACKGROUND ART

### Background of Wavelength Conversion Technique

The wavelength conversion technique has been highly noticed in a wavelength region in which it cannot be directly outputted by a semiconductor laser or in applications in which it requires a high output intensity which cannot be obtained by a semiconductor laser even if it can be directly outputted by the semiconductor laser as a wavelength region.

### Description of Application Fields of PPLN

Above all, an optical waveguide utilizing periodically poled lithium niobate (Hereinafter, referred to as PPLN) is a feasible element of achieving an increase in light intensity by using the waveguide and a high wavelength conversion efficiency by using a quasi-phase matching technique, and expected to be used in optical signal conversion in optical communications and a wide range of optical wavelength band from the ultraviolet range to visible range, infrared range, and terahertz range for applications such as optical processing, medicine, and biological engineering.

Furthermore, since a parametric amplifying element and an excitation light generating element constituting a phase sensitive amplifier (PSA) capable of low-noise optical amplification by an optical waveguide utilizing PPLN can be manufactured, high-gain and low-noise optical amplification characteristics are realized, and applications as an element which plays an important role in the field of next generation optical fiber communication have been considered.

In the field of quantum computing, an optical waveguide utilizing PPLN is inserted into a fiber ring resonator and used as a parametric oscillation element to realize an optical coherent ising machine apparatus, and it has been reported that a large capacity calculation is demonstrated at a very high speed as compared with a conventional computer.

In order to further improve the performance of these techniques, it is important to realize a wavelength conversion apparatus having a higher wavelength conversion efficiency.

### Description of Quadratic Nonlinear Optical Effect and Phase Matching Condition

In general, when a signal light (Signal light) [wavelength: λ₁, frequency: ω₁) and an excitation light (Pump light) [wavelength: λ₂, frequency: ω₂] with different wavelengths are injected into a second-order nonlinear optical crystal, the wavelength conversion light (also referred to as idler light) [wavelength: λ₃, frequency: ω₃] generates light with a wavelength according to a relationship called the phase matching condition.

The case where the sum frequency generation ω₃=ω₁+ω₂ is considered. Since the momentum of a photon is

$$ℏ k \qquad [ Math . 1 ]$$

if the wavenumber mismatch is Δk, the following relationship follows from the momentum conservation law.

$$\begin{matrix}[ Math . 2 ] & \\ ℏΔ k = h ( {k}_{3} - {k}_{1} - {k}_{2} ) & ( Formula 1 )\end{matrix}$$

$$Therefore ,$$

$$Δ k = {k}_{3} - {k}_{1} - {k}_{2} \qquad ( Formula 2 )$$

When the length of the second-order nonlinear optical crystal through which light propagates is L and the propagation direction is Z direction, the nonlinear polarization P_{z} (ω₁+ω₂) changes in phase at exp [i (k₁+k2) Z].

$$Exp ( {ik}_{3} \cdot z ) - exp [ i ( {k}_{1} + {k}_{2} ) \cdot Z ] = exp [ i ( {k}_{3} - {k}_{1} - {k}_{2} ) \cdot Z ] = exp [ i Δ k \cdot Z ] \qquad ( Formula 3 )$$

Since the phase of the generated amplitude E (ω3) is exp (ik₃·Z), a phase difference of Δk L will result, by the Δk satisfied with above Formula 3 between both.

When the phase difference exceeds π, the phase is inverted and the direction in which energy flows is inverted, and a process in which ω₃ photon is divided into ω₁ and ω₂ occurs.

Thus, the light wave of the sum frequency component that has been created begins to decrease.

$${L}_{c} = Π / ( \vert Δ k \vert ) \qquad ( Formula 4 )$$

Here, the distance L_{c}, in which the phase is inverted, shown by the above Formula 4, is referred to as a coherence length.

Further, when the phase difference exceeds 2π (that is, the propagation length of light exceeds twice the coherence length), the direction in which the energy flows return to the original state again, and it can be seen that the nonlinear polarization Pz increases and decreases with a period of twice the coherence length (increase and decrease are exchanged for each coherence length).

For this reason, in order to increase the generation efficiency of the wavelength conversion light, the coherence length at which attenuation starts must be made longer than the crystal length propagating.

In particular, the condition Δk=0 in which wavenumber mismatch is eliminated is referred to as a phase matching condition, which is a condition for generating wavelength conversion light.

At this time, when two light waves having frequencies ω₁ and ω₂ are input to the second-order nonlinear material as described above and light having frequencies ω₃ (=ω₁+ω₂) is generated, it is called sum frequency generation (SFG).

On the other hand, when two light waves having frequencies ω₁ and ω₃ are input to the second-order nonlinear material and light having ω₂ (=ω₃−ω₁) is generated, it is called difference frequency generation (DFG).

A phenomenon in which light of ω₃ having a high light intensity is incident and two light waves of frequencies ω1 and ω2 are generated is called an optical parametric effect.

Here, considering a case where all the combined light waves travel in the same direction, since the wavenumber mismatch Δk is expressed following formula,

$$Δ k = 2 Π ( {n}_{3} / {λ}_{3} - {n}_{1} / {λ}_{1} - {n}_{2} / {λ}_{2} ) \qquad ( Formula 5 )$$

the phase matching condition is expressed as follows.

$${n}_{3} / {λ}_{3} = {n}_{1} / {λ}_{1} + {n}_{2} / {λ}_{2} \qquad ( Formula 6 )$$

$$or$$

$${ω}_{1} {n}_{1} + {ω}_{2} {n}_{2} = {ω}_{3} {n}_{3} \qquad ( Formula 7 )$$

At this time, n₁, n₂ and n₃ are the refractive indexes of the propagating second-order nonlinear material at each wavelength: λ₁, λ₂, λ₃ (each frequency: ω₁, ω₂, ω₃). The formula (Formula 7) means that the weighted average of n₁ and n₂ is equal to n₃ with the frequency as a weight.

The phase matching condition is satisfied when the refractive indexes of the fundamental and the doubled wave are equal, especially in the second harmonic generation when the polarizations of the coupled fundamental photons are the same.

In practice, however, the phase matching condition is not easily satisfied because materials always have refractive index wavelength dispersion.

For this reason, in a uniform medium, there have been studied a method of (1) utilizing refractive index dispersion by crystal orientation of a birefringent crystal (anisotropy to linearly polarized light), (2) utilizing refractive index dispersion by an optically active substance (anisotropy to circularly polarized light), and (3) utilizing abnormal dispersion due to resonance. The method of (1) is easy to control by angle and temperature and is most widely used, and in the case of angle control, realizes phase matching condition Δk=0 and generates wavelength conversion light, by using the angle matching method of non-parallel alignment that vectorially satisfies the phase matching condition that angles the propagation direction of the interacting light waves. However, this angle matching method has a problem that the maximum nonlinear constant of the nonlinear optical crystal cannot be utilized.

On the other hand, optical waveguides and photonic crystals, which control the propagation structure of light, feature a much wider degree of freedom in controlling the phase speed because of material dispersion on the basis of the refractive index, structural dispersion dependent on a dimension and a shape of a cross section, and mode dispersion dependent on the mode order.

### (Description of Quasi-Phase Matching)

Although the above method is a method for eliminating the wavenumber mismatch Δk=0, there is a quasi-phase matching method which permits the wavenumber mismatch and modulates the nonlinear susceptibility to cancel the effect of the phase shift. This is a technique for achieving pseudo phase matching by a structure in which the sign of the nonlinear susceptibility is periodically inverted. As described above, since the nonlinear polarization increases or decreases with a length twice as long as the coherence length as a period, the nonlinear polarization waves generated from each point are added together without canceling each other by setting twice as long as the coherence length as the polarization inversion period (polarization inversion is performed at the coherence length interval), and the effect can be generated as if the phase mismatching amount were zero in a pseudo manner.

If the polarization reversal period is λ, then Formula 8 follows from the formula (Formula 4) of the coherent length.

$$Λ = 2 \cdot {L}_{c} \qquad ( Formula 8 )$$

Considering the case where all coupled light waves travel in the same direction, from (Formula 4), the wavenumber mismatch is non-zero, and is Formula 9.

$$Δ k = 2 Π ( {n}_{3} / {λ}_{3} - {n}_{1} / {λ}_{1} - {n}_{2} / {λ}_{2} ) = 2 Π / Λ \qquad ( Formula 9 )$$

Therefore, Formula 10 is obtained and formula (Formula 8) is the phase matching condition for quasi-phase matching (QPM).

$${n}_{3} / {λ}_{3} - {n}_{2} / {λ}_{2} - {n}_{1} / {λ}_{1} - 1 / Λ = 0 \qquad ( Formula 10 )$$

Here, n₃ is a refractive index at a wavelength λ₃, n₂ is a refractive index at a wavelength λ₂, and n₁ is a refractive index at a wavelength λ₁.

Unlike the angle matching method described above, this quasi-phase matching method can use a material orientation with the largest nonlinear susceptibility component, such as a second-order nonlinear crystal. In addition, it has the advantage that the operating wavelength region can be set by selecting the inversion period, and the use of optical waveguides enables light to be confined densely in a narrow area and propagated over long distances, thus highly efficient wavelength conversion has been realized so far.

### (Description of QPM Optical Waveguide Fabrication Method)

There are also known a method of manufacturing an optical element (hereinafter referred to as a wavelength conversion element) which performs wavelength conversion by using a quasi-phase matching technique. For example, a method of manufacturing a proton exchange waveguide by using a periodically-poled inversion structure after a crystal (hereinafter referred to as a nonlinear optical crystal) substrate expressing a nonlinear optical effect is formed into the periodically-poled inversion structure. For example, a ridge-type optical waveguide is manufactured by using a photolithography process and a dry etching process after forming a nonlinear optical crystal substrate into a periodically-poled inversion structure.

PTL 1 discloses an example of one of these, in which a ridge-type optical waveguide is fabricated. In PTL 1, it is described that in order to improve the confinement effect of light in a ridge-type optical waveguide, a first substrate of a nonlinear optical crystal having a periodically-poled inversion structure and a second substrate having a refractive index smaller than that of the first substrate are bonded to each other to manufacture a wavelength conversion element. In PTL 1, it is described that a nonlinear optical crystal of the same type as that of the first substrate is used as the second substrate in order to avoid cracks due to deterioration of the adhesive or temperature change, and heat is applied to the first substrate and the second substrate to perform diffusion bonding.

### (Importance and Problems of Optical Amplifiers in Optical Transmission Systems)

On the other hand, On the other hand, an identification reproduction optical repeater for converting an optical signal into an electric signal and reproducing the optical signal after identifying a digital signal is used in order to reproduce the optical signal attenuated by propagation through an optical fiber in a conventional optical transmission system. However, in this identification reproduction optical repeater, there are problems that there is a limit in response speed of electronic components for converting an optical signal into an electric signal, and that power consumption increases when the speed of a signal to be transmitted increases.

### (Features of Conventional EDFA (PDFA) Optical Amplifiers)

As an optical amplifying means for solving this problem, there are a fiber laser amplifier or a semiconductor laser amplifier for amplifying signal light by making excitation light incident on an optical fiber to which a rare earth element such as erbium or praseodymium is added. The fiber amplifier doped with erbium is called erbium doped fiber amplifier (EDFA). The fiber amplifier to which praseodymium is added is called a praseodymium doped fiber amplifier (PDFA). Since such a fiber laser amplifier and a semiconductor laser amplifier can amplify signal light as it is, there is no limitation on the electrical processing speed which has been a problem in the identification reproduction optical repeater. In addition, the configuration of the apparatus has the advantage of being relatively simple.

### (Description of Problems of Conventional EDFA (PDFA) Optical Amplifiers and Degradation of S/N Characteristics)

However, these laser amplifiers do not have a function of shaping the deteriorated signal light waveform. In these laser amplifiers, spontaneously-emitted light, which is inevitable and randomly generated, is mixed in completely independently of the signal component, so the S/N (Signal to Noise ratio) of the signal light decreases by at least 3 dB before and after amplification. The lack of the waveform shaping function and the reduction of the S/N leads to the increase of the transmission code error rate at the time of transmitting the digital signal, which causes the reduction of the transmission quality.

### (Explanation of Phase Sensitive Amplification (PSA))

A phase sensitive amplifier (PSA) is being considered as a means of overcoming these limitations of conventional laser amplifiers. The PSA has the ability to shape signal light waveforms and phase signals that have been degraded due to the effects of dispersion in the transmission fiber. Also, since spontaneously-emitted light having a quadrature phase unrelated to the signal can be suppressed and spontaneously-emitted light of the same phase can also be minimized, it is possible in principle to maintain the same S/N of the signal light before and after amplification without degradation.

### (Description of PSA Configuration)

FIG. 1 is a schematic block diagram showing the basic structure of a conventional PSA. As shown in FIG. 9, the overall phase sensitive amplifier (PSA) 100 consists of a phase-sensitive optical amplification unit 101 using optical parametric amplification, an excitation light source 102, an excitation light phase control unit 103, and first and second optical branch parts 104a and 104b. As shown in FIG. 1, a signal light 110 input to the PSA 100 is branched into two by the optical branch part 104a, one of which is incident on the phase-sensitive optical amplification unit 101 and the other of which is incident on the excitation light source 102. Excitation light 111 emitted from the excitation light source 102 has its phase adjusted via the excitation light phase control unit 103, and is incident on the phase-sensitive optical amplification unit 101. The phase-sensitive optical amplification unit 101 outputs an output signal light 112 based on the input signal light 110 and the excitation light 111.

As nonlinear optical media for performing the above-described optical parametric amplification, a method of using a second-order nonlinear optical material represented by a periodically poled LiNbO₃ (PPLN) waveguide and a method of using a third-order nonlinear optical material represented by a quartz glass fiber are known.

### (Description of Operation Principle of PSA)

The phase-sensitive optical amplification unit 101 has a characteristic of amplifying the signal light 110 when the phase of the incident signal light 110 and the phase of the excitation light 111 match each other, and attenuating the signal light 110 upon entering a quadrature phase relationship in which the phases of the two are shifted by 90 degrees. When the phases of the excitation light 111 and the signal light 110 are matched such that the amplification gain is maximized using this characteristic, spontaneously-emitted light in orthogonal phase to the signal light 110 is not generated, and no excess spontaneous emission light beyond the noise of the signal light 110 is generated with respect to the in-phase component. Therefore, the signal light 110 can be amplified without deteriorating the S/N.

In order to achieve such phase synchronization of the signal light 110 and the excitation light 111, the excitation light phase control unit 103 controls the phase of the excitation light 111 so as to synchronize with the phase of the signal light 110 branched by the first optical branching portion 104a. In addition, the excitation light phase control unit 103 detects part of the output signal light 112 branched by the second optical branching portion 104b with a narrow band detector, and controls the phase of the excitation light 111 such that the gain amplification of the output signal light 112 is maximized. As a result, in the phase-sensitive optical amplification unit 101, optical amplification without deterioration of the S/N is realized using the above-described principle.

### (Supplementary Explanation of Using Source Light of Signal Light as Source Light of Excitation Light)

Note that the excitation light phase control unit 103 may also have a configuration in which the phase of the excitation light source 102 is controlled directly, other than the configuration in which the phase of the excitation light 111 is controlled on the output side of the excitation light source 102. Also, if the light source generating the signal light 110 is located near the phase-sensitive optical amplification unit 101, part of the light source for the signal light can be branched and used directly as excitation light because the amount of phase variation is smaller.

### (Description of Problems of PSA)

However, in the conventional phase sensitive amplifier (PSA) technique, there is a problem that the phase synchronization between the signal light and the excitation light must be performed. The reason for this is explained in detail below using a phase locked loop (PLL).

### (Description of Phase Locked Loop (PLL) Circuit Configuration)

FIG. 2 is a block diagram showing a structure of a conventional PSA using a PPLN waveguide disclosed in NPL 1 and the like. The PSA 200 shown in FIG. 10 includes an erbium-doped fiber laser amplifier (EDFA) 201, first and second second-order nonlinear optical elements 202 and 204, first and second optical branch parts 203a and 203b, a phase modulator 205, an optical fiber expander 206 using a PZT (lead zirconate titanate) piezoelectric element, a polarization maintaining fiber 207, a photodetector 208, and a phase locked loop (PLL) circuit 209. The first second-order nonlinear optical element 202 includes a first spatial optical system 211, a first PPLN waveguide 212, a second spatial optical system 213, and a first dichroic mirror 214. The second second-order nonlinear optical element 204 includes a third spatial optical system 215, a second PPLN waveguide 216, a fourth spatial optical system 217, a second dichroic mirror 218, and a third dichroic mirror 219. The first spatial optical system 211 couples the inputted light from an input port of the first second-order nonlinear optical element 202 to the first PPLN waveguide 212. The second spatial optical system 213 couples the outputted light from the first PPLN waveguide 212 to the output port of the first second-order nonlinear optical element 202 via the first dichroic mirror 214. The third spatial optical system 215 couples the light input from the input port of the second second-order nonlinear optical element 204 to the second PPLN waveguide 216 via the second dichroic mirror 218. The fourth spatial optical system 217 couples the outputted light from the second PPLN waveguide 216 to the output port of the second second-order nonlinear optical element 204 via the third dichroic mirror 219.

### (Description of Phase Locked Loop (PLL) Operation Principle)

In the example shown in FIG. 2, the signal light 250 incident on the PSA 200 is split by the optical branching portion 203a, with one light incident on the second second-order nonlinear optical element 204. The other light bifurcated by the optical branching portion 203a is phase-controlled by the phase modulator 205 and the optical fiber expander 206 as the excitation fundamental wave light 251 and enters the EDFA 201. To obtain sufficient power to obtain the nonlinear optical effect from the weak laser light used in optical communications, EDFA 201 amplifies the incoming excitation fundamental wave light 251 and injects the amplified excitation fundamental light 251 into the first second-order nonlinear optical element 202.

In the first second-order nonlinear optical element 202, second harmonic light (hereinafter referred to as SH light) 252 is generated from the incident excitation fundamental wave light 251. The generated SH light 252 enters the second second-order nonlinear optical element 204 through the polarization maintaining fiber 207. In the second second-order nonlinear optical element 204, phase sensitive amplification is performed by performing degenerate parametric amplification with the incident signal light 250 and the SH light 252, and an output signal light 253 is output. In the PSA, in order to amplify only the light that is in phase with the signal, it is necessary that the phase of the signal light and the phase of the excitation light match each other as described above or are shifted by n radians. That is, if the second-order nonlinear optical effect is to be used, it is necessary that the phase φ_{2ωs} of the excitation light, which has a wavelength corresponding to that of the SH light, and the phase φ_{ωs} of the signal light satisfy the following relationship of (Formula 11).

$$Δφ = 1 / 2 ( {φ}_{2 ω s} - {φ}_{ω s} ) = n Π ( where , n is an integer ) \qquad ( Formula 11 )$$

(Description of Importance of Phase Synchronization between Excitation Light and Signal Light)

FIG. 3 is a graph showing the relationship between the phase difference Δφ between the input signal light and the excitation light and the gain (dB) in the PSA using the conventional second-order nonlinear optical effect. FIG. 11 shows that the gain is maximum when the phase difference Δφ between the input signal light and the excitation light is −π, 0, or π.

The phase modulator 205 shown in FIG. 2 performs phase modulation on the excitation fundamental wave light 251 in accordance with a weak pilot signal. A second optical branching portion 203b branches a part of the amplified output signal light 253 and makes it incident on a photodetector 208. The photodetector 208 converts the incident signal light into an electrical signal. The pilot signal component is minimum when the phase difference Δφ shown in FIG. 3 is minimum, that is, when phase synchronization is achieved.

Therefore, a phase locked loop circuit (PLL) 209 is used to provide feedback to the optical fiber expander 206 so that the pilot signal is minimized, that is, the amplified output signal detected by the photodetector 208 is maximized. An optical fiber expander 206 expands and contracts the optical fiber through which the excitation fundamental wave light 251 propagates in accordance with the output of the phase locked loop circuit 209. In this way, the phase of the excitation fundamental wave light 251 can be controlled to achieve phase synchronization between the signal light 250 and the excitation fundamental light 251. In the configuration for degenerate parametric amplification by using the above PPLN waveguide as a nonlinear medium and injecting the signal light 250 and SH light 252 into the second second-order nonlinear optical element 204, at the time that the SH light 252 is once generated and then parametrically amplified, by using the characteristics of the dichroic mirror 214 to remove component of the excitation fundamental wave light, only the SH light 252 and signal light 250 can be injected into a parametric amplifying medium such as the second secondary nonlinear optical element 204. This prevents noise due to the mixing of spontaneously-emitted light generated by the EDFA 201, thus enabling low-noise optical amplification.

### CITATION LIST

### Non Patent Literature

[NPL 1] T. Umeki, et al., “Phase sensitive degenerate parametric amplification using directly-bonded PPLN ridge waveguides”, Optics Express, 2011, Vol. 19, No. 7, pp. 6326-6332

### PATENT LITERATURE

[PTL 1] Japanese Patent No. 3753236
[PTL 2] Japanese Patent Application Publication No. 2019-105796

### SUMMARY OF INVENTION

### (Description of Current LN Module)

As shown in FIG. 2, in a phase sensitive amplifier (PSA), optical input/output is formed by an optical fiber, and optical coupling of optical input/output is formed by a pigtail module of the optical fiber, like first and second second-order nonlinear optical elements 202 and 204.

### (Optical Fiber Pigtail Module Structure and Advantages)

On the other hand, the mounting of the spatial optical system using the optical surface plate is to assemble an optical system having a high degree of flexibility, but it is relatively large in size, and it is difficult to handle and attach and detach the optical system. Therefore, in the current optical system mounting, an optical fiber pigtail type mounting module which is terminated by an optical connector is used.

For example, as a wavelength conversion apparatus using PPLNs, a module mounting structure of a wavelength conversion apparatus 400 with a pigtail structure of optical fibers with two inputs and outputs each is shown in FIG. 4 of PTL 2.

FIG. 4 is a diagram showing the configuration of a wavelength conversion apparatus according to the prior art. An input (fiber 410 for signal light) of the signal light 404 and an output (fiber 403 for signal light) of the signal light 412 are provided on opposite end faces of the housing of the wavelength conversion apparatus, respectively. Input/output (fiber 411 for excitation light, fiber 415 for excitation light, and lenses 406a, 408b) of excitation light are provided on surfaces other than these end surfaces. A lens 406b, a dichroic mirror 413 and a lens 407 are provided between an input and a wavelength conversion element 414 provided with an optical waveguide core 414b, a lens 408a, a dichroic mirror 416 and a lens 409 are provided between a wavelength conversion element 414 and an output, and the configuration allows optical connection.

An optical fiber pigtail type mounting module has a mounting structure in which an optical function member such as a light source and an optical modulator is fixed by metal fusion or an adhesive after the optical system is arranged and adjusted in a rigid housing made of metal or the like, and input and output of light is taken out by an optical fiber cable.

The advantage of the optical fiber pigtail module is that the use of an optical fiber with an optical connector makes it easy to handle by attaching and detaching the optical connector, increasing the degree of freedom of assembly in the equipment and allowing easy replacement in case of module failure.

In addition, modularization of the optical system has the advantage of not only enabling miniaturization, but also reducing the work required to assemble the system into equipment by eliminating the need for adjustments.

(Problem with Optical Fiber Pigtail Module)

However, optical fibers experience an increase in optical loss when the radius of curvature is less than 30 mm according to the specification value of the international standard ITU-T G652. Further, the glass core wire of the optical fiber core can be damaged by steep bending or impact, resulting in very high optical loss or inability to realize transmission of optical signals.

Since the optical fiber itself is broken when it is wound with a radius of curvature of the millimeter order or less, wiring arrangement of a minimum number of cm or more is required, since the junction between the module housing and the optical fiber wiring is a point where stress is easily concentrated, it is necessary to form an optical input and output port with a mechanical reinforcement structure.

Therefore, handling of optical fibers and handling such as curvature radius during mounting requires attention to loss increase and damage, as mentioned above. In mounting the optical fiber pigtail module, it is possible to limit the optical fiber length to some extent by designing the required optical fiber length in the case of optical connector connection. However, in the case of cutting optical fibers for fiber end-facing or splicing optical fibers by fiber fusion splicing, or in the case of manufacturing as general optical modules, it is actually necessary to connect optical fibers with sufficient extra length to allow for component replacement or repair later. Therefore, in actual optical system, optical fibers are fixed by using reel-like members that wind up excess optical fibers, adhesive tape, or binding members.

### (Problem of Optical Mounting Structure in Multi-Core Array Optical Input and Output Module)

In particular, in the case of a multi-channel optical module in which a large number of optical inputs and outputs are taken out from one mounting housing, the more the number of optical inputs and outputs is increased, the more difficult the arrangement of the optical fiber take-out position and the optical fiber handling position.

### (Problem of Optical Phase Synchronization)

In addition to the above, in the case of a phase sensitive amplifier (PSA), it is necessary to synchronize the optical phases of the phase-sensitive optical amplification unit and the excitation light source as described above in order to improve the S/N.

That is, it is necessary to adjust the optical phase between the mounting housings of the plurality of optical fiber pigtails, and it is necessary to synchronize the optical phases in the plurality of inputs and outputs even in the same mounting housing.

### (Problem of Optical Phase Synchronization by Multi-Core Array Optical Input and Output Modules)

However, since the optical phase distance of an optical fiber fluctuates slightly in response to external forces, it is difficult to adjust the optical phase simply by the optical fiber length alone when the optical fiber length is long, and it depends on the state of fixation in the mounting housing. Further, even if a plurality of optical fibers having almost the same optical fiber length such as a tape optical fiber, an optical phase shift called skew occurs due to external force such as the winding state of the tape.

Therefore, it is required to realize a mechanism capable of adjusting the optical phase with high accuracy in the optical path other than the optical fiber cable.

### (Problem in Supporting Polarization Diversity)

Further, in a wavelength conversion element fabricated with a PPLN optical waveguide using a nonlinear optical crystal with the periodically-poled inversion structure described above, the quasi-phase matching (QPM) condition is basically satisfied for only one optical polarization due to the anisotropy of the nonlinear optical crystal, and realizes in wavelength conversion. Therefore, it is difficult to realize wavelength conversion at a time with respect to the input of non-polarized light.

The means to solve the aforementioned problems are as follows.

As a result of intensive studies in view of the above-mentioned problems, the inventors have studied the mounting structure of the optical module and found that optimizing the position of optical input and output extraction in the optical fiber pigtail module makes it possible to provide a mounting structure with high mounting density and excellent optical fiber handling when it comes to multiple optical inputs and outputs, and found that the optical phase and the optical polarization can be controlled by providing an optical path length adjustment mechanism and a mechanism for polarization merging, separation and polarization rotation within the mounting housing, and then the present invention was completed.

In order to solve the above problems, a wavelength conversion apparatus of the present embodiment comprising: a wavelength conversion element for converting a wavelength of a signal light having an optical waveguide core and a substrate having a lower refractive index for the signal light and the excitation light than the optical waveguide core; and a temperature control element for controlling temperature of the wavelength conversion element, wherein an excitation light of the wavelength of the signal light and n₁ (n₁ being zero and a positive integer) excitation lights that differ from the wavelength of the signal lights are inputted when one or more m₁ (m₁ being a positive integer) signal lights are inputted, an excitation light of the wavelength of the signal light and n₂ (n₂ being zero and a positive integer) excitation lights that differ from the wavelength of the signal lights are inputted when one or more m₂ (m₂ being a positive integer) signal lights are outputted, and in a wavelength conversion apparatus that generates a light of differential frequency wavelength, the signal light and the excitation light are inputted from one side of a housing adjacent to and opposite optical input and output of the wavelength conversion element, and the signal light and the excitation light are outputted from the other side of the opposite housing.

(2) Another invention according to an embodiment of the present invention is characterized in that a wavelength conversion apparatus comprises a wavelength conversion element for converting a wavelength of a signal light having an optical waveguide core and a substrate having a lower refractive index for the signal light and the excitation light than the optical waveguide core; and a temperature control element for controlling temperature of the wavelength conversion element, wherein an excitation light of the wavelength of the signal light and n₁ (n₁ being zero and a positive integer) excitation lights that differ from the wavelength of the signal lights are inputted when one or more m₁ (m₁ being a positive integer) signal lights are inputted, an excitation light of the wavelength of the signal light and n₂ (n₂ being zero and a positive integer) excitation lights that differ from the wavelength of the signal lights are inputted when one or more m₂ (m₂ being a positive integer) signal lights are outputted, and in the wavelength conversion apparatus that generates light of differential frequency wavelengths, an output that outputs the signal light and the excitation light by inputting the signal light and excitation light is provided, a telescopic mechanism to vary the propagation path distance of light input of the optical input to the wavelength conversion element of at least any one of the respective optical inputs and outputs of the signal light or the excitation light is provided, or at least any one of a polarization separation element and a polarization rotation element is provided on the way of the propagation path of the optical input to at least one of the wavelength conversion elements.

According to the present invention, an efficient and compact mounting structure of an optical fiber pigtail module can be realized in a large number of input and output wavelength conversion elements. Further, by varying the optical distance of each optical input and output, separating and rotating polarized waves, it is possible to provide a function of adjusting the optical phase distance required for the wavelength conversion apparatus and a wavelength conversion apparatus independent of polarization.

### BRIEF DESCRIPTION OF DRAWINGS

FIG. 1 is a schematic block diagram showing a basic configuration of a conventional PSA.

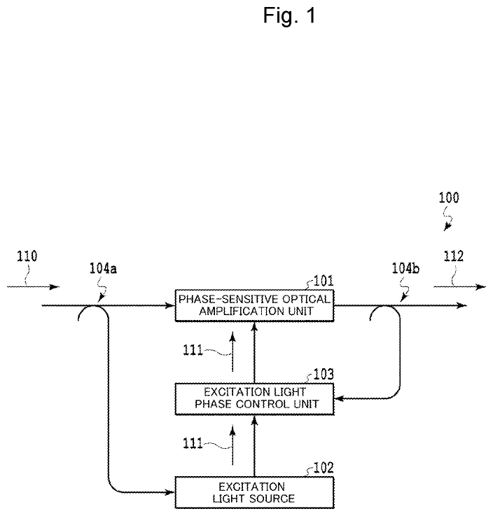

FIG. 2 is a block diagram showing a configuration of a conventional PSA using a PPLN waveguide.

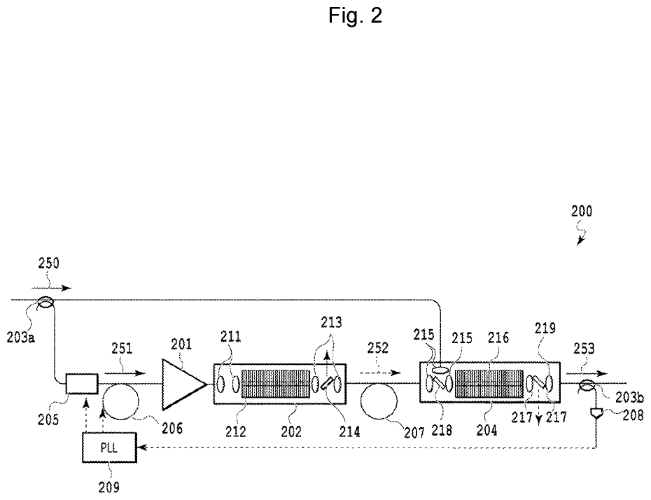

FIG. 3 is a graph showing a relationship between a phase difference Δφ between the input signal light and an excitation light and gain (dB) in a PSA using the conventional second-order nonlinear optical effect.

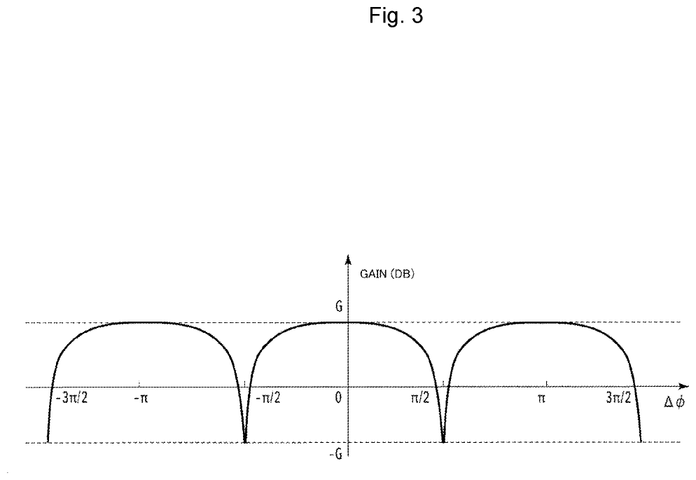

FIG. 4 is a diagram of a configuration example of a wavelength conversion apparatus of a reference literature.

FIG. 5 is a schematic diagram (1) of a first embodiment of the present invention.

FIG. 6 is a schematic diagram (2) of the first embodiment of the present invention.

FIG. 7 (a) is a top view of the wavelength conversion element, and FIG. 7 (b) shows a cross-sectional view of a wavelength conversion element.

FIG. 8 (a) shows a top view of a wavelength conversion element with a temperature control element mounted, and FIG. 8 (b) shows a cross-sectional view of a wavelength conversion element with a temperature control element mounted.

FIG. 9 is a schematic diagram (1) of a second embodiment of the present invention.

FIG. 10 is a schematic diagram (2) of the second embodiment of the present invention.

FIG. 11 is a schematic diagram (3) of the second embodiment of the present invention.

FIG. 12 is a schematic diagram (1) of a third embodiment of the present invention.

FIG. 13 is a schematic diagram (2) of the third embodiment of the present invention.

FIG. 14 is a schematic diagram (3) of the third embodiment of the present invention.

FIG. 15 is a schematic configuration diagram of the reference module in an example 1 of the present invention.

FIG. 16 is a schematic configuration diagram of the example 1 of the present invention.

### DESCRIPTION OF EMBODIMENTS

An embodiment of the present invention will be described in detail below with reference to the drawings. The same reference numerals have the same functions, and the description thereof may be omitted.

### (First Embodiment) [Description of Multi-core Array Mounting Structure (Optical Input-Output Arrangement at Opposite Housing Surfaces)]

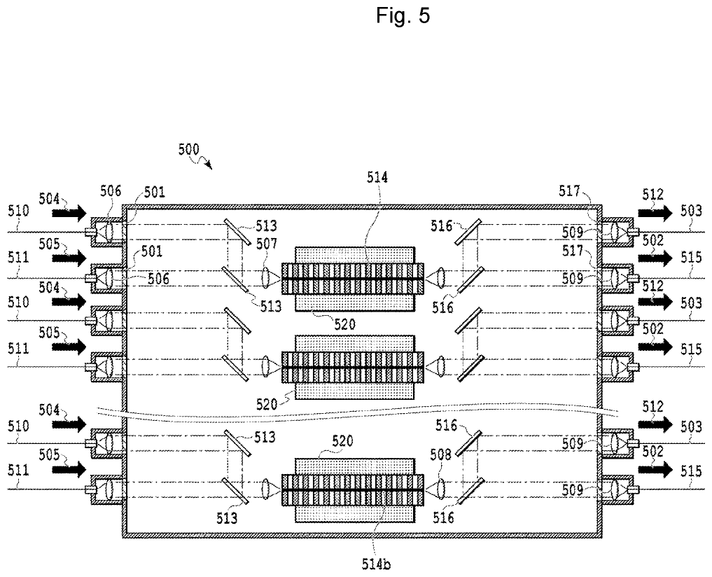

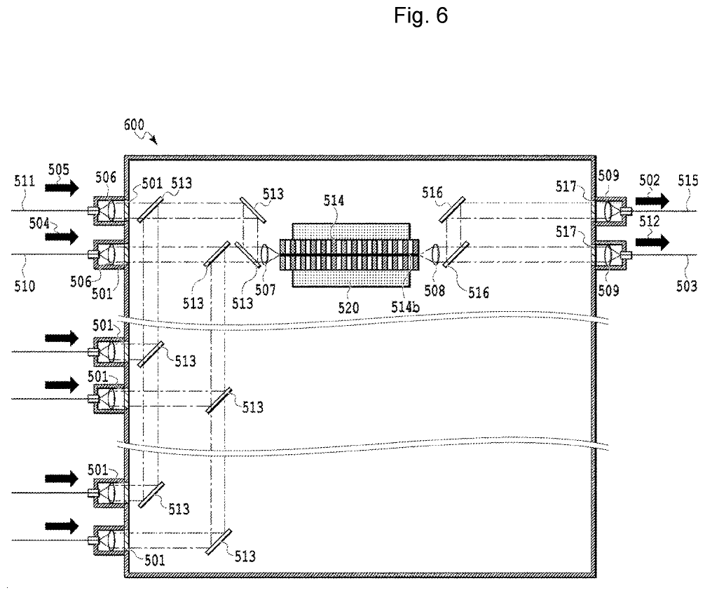

FIG. 5 and FIG. 6 are schematic diagrams of a first embodiment of the present invention.

The first embodiment of the invention comprises an optical waveguide core 514b, a wavelength conversion element 514 that converts the wavelength of signal light having a lower refractive index than the optical waveguide core 514b for signal light 504 and excitation light 505, and a temperature control element 520 for controlling the temperature of the wavelength conversion element. As shown in FIGS. 5 and 6, in a wavelength conversion apparatus 500 that generates light of the wavelength of the difference frequency, a signal light 504 and an excitation light 505 are input from one side of the enclosure adjacent to and opposite the optical input and output of the wavelength conversion element 514, and the outputs of the signal light 512 and the excitation light 502 on the other side of the opposite housing are provided on the other side of the opposite housing. The signal light 512 is input from a fiber for signal light 503 to the housing, and the excitation light 502 is output from the housing to a fiber for excitation 515.

The housing is provided with a lens 506, a sealing window 501, spatial optical system 513, and a lens 507 between the input, and the wavelength conversion element 514, and a lens 508, spatial optics 516, sealing window 517, and lens 509 between the wavelength conversion element 514 and the output. Optical connection between input and output is enabled.

As for the mounting structure of the wavelength conversion apparatus 500, as mentioned above, the pigtail structure of the optical fiber allows the space for processing the extra length of optical fiber in the case of optical input and output, and the optical input fiber (fiber for signal light 510 and the fiber 511 for excitation light) and optical output fibers (the fiber 503 for signal light and the fiber for excitation light 515) in the case of mounting a plurality of array-shaped optical input and output should be desirable to bring together on each wall surface of the mounting housing. Further, since the wavelength conversion element 514 is an optical waveguide of a dielectric having a quasi-phase matching structure, the wavelength conversion element 514 is often a long and thin structure, so that it is desirable to take out the optical input and output from the opposing mounting housing for input and output of light as in the first embodiment. Since the signal light and the excitation light are multiplexed and demultiplexed and input and output to and from the wavelength conversion element, it is most desirable to mount the optical input and output fibers side by side on the opposite housing side wall surface of the mounting housing opposite to both ends of the long and narrow wavelength conversion element.

### (Description of Wavelength Conversion Elements)

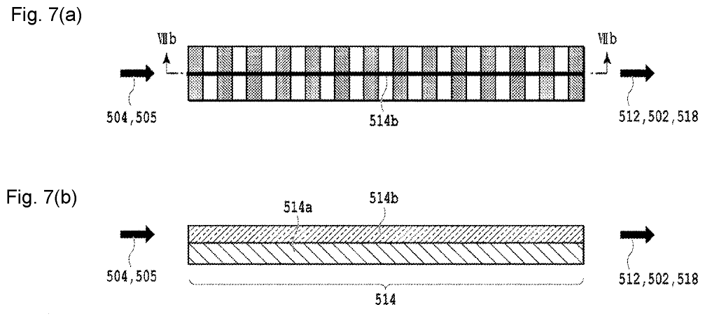

FIG. 7 is a schematic diagram of a wavelength conversion element. FIG. 7 (a) is a top view of the wavelength conversion element, and FIG. 7 (b) is a cross-sectional view of the wavelength conversion element.

The optical waveguide core 514 b is an optical waveguide for selectively transmitting the signal light through its inside without losing the intensity of the signal light. The structure of the optical waveguide core 514b is not particularly limited as long as it has a function of outputting wavelength conversion light (idler light) 518 having a wavelength different from that of the signal light 504 by the secondary nonlinear optical effect of the optical waveguide core when the wavelength of the signal light 504 is input and the excitation light 505 is made incident from an optical path similar to the signal light 504. For the optical waveguide core 514b, a so-called slab optical waveguide structure or ridge optical waveguide structure is used to propagate signal light or excitation light by forming an external structure in which the core film thickness is thicker only in the light propagation area, or a so-called proton-implanted optical waveguide in which the refractive index is relatively larger in the part that serves as the optical waveguide core than in other parts, or an The second-order nonlinear constant varies periodically or with a predetermined modulation along the direction of light travel to achieve quasi-phase matching for a single wavelength or multiple wavelengths. For example, a multi-QPM element in which quasi-phase matching of a plurality of periods is complexed can be adopted for the optical waveguide core 514b.

The substrate 514a is preferably a material which is transparent to at least the signal light, that is, does not cause light absorption, and preferably a material which does not cause light absorption to both the signal light 504 and the excitation light 505. To reduce the effects of thermal stress and other factors between the optical waveguide core 514b and the substrate 514a, the substrate 514a is preferably a material which is a ferroelectric material with similar physical properties to the optical waveguide core, and the substrate 514a functions as an under cladding to the optical waveguide core when constructing a ridge-type optical waveguide. The substrate 514a should have a lower refractive index than the optical waveguide core 514b with respect to the signal light 512, the excitation light 502, and the wavelength-converted signal light.

LiNbO₃, KNbO₃ (potassium niobate), LiTaO₃ (lithium tantalate), LiNb(x)Ta(1−x)O₃ (0≤x≤1) (lithium tantalate with indefinite composition) or KTiOPO₄ (potassium titanate phosphate) is selected as the optical waveguide core 514b or the ferroelectric material adopted for the substrates, furthermore at least one of Mg (magnesium), Zn (zinc), Sc (scandium), or In (indium) as an additive to them should be selected and contained.

### (Description of Temperature Control Element)

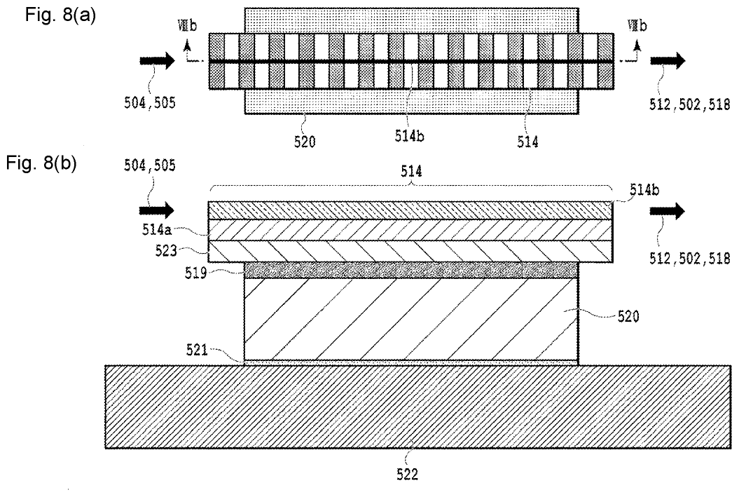

FIG. 8 is a schematic view of a wavelength conversion element on which a temperature control element 520 is mounted. FIG. 8 (a) is a top view of the wavelength conversion element on which the temperature control element is mounted, and FIG. 8 (b) is a cross-sectional view of the wavelength conversion element on which the temperature control element is mounted.

The wavelength conversion efficiency of the wavelength conversion element 514 has temperature dependency, and it is necessary to adjust the temperature of the wavelength conversion element 514 and maintain the temperature at a constant temperature so as to maximize the wavelength conversion efficiency. Further, since the wavelength of the wavelength conversion light (idler light) 518 also depends on the temperature of the wavelength conversion element 514, it is necessary to adjust the temperature of the wavelength conversion element and maintain the temperature at a constant temperature in order to control the wavelength of the wavelength conversion light (idler light) 518 with high accuracy. In order to adjust the temperature of the wavelength conversion element 514, a method using a heat source such as a heater generating heat by resistance heating as the temperature control element 520, and a method using a Peltier element capable of heating and cooling by current control can be cited. As shown in FIG. 8, in order to uniformly and efficiently conduct heat generation or the like to the temperature control element 520, it is desirable to mount and fix the temperature control element 520 to the mounting housing by a supporting member bonded to the wavelength conversion element 514 or a bonding material 519 having excellent thermal conductivity such as a cured resin containing a metal filler.

(Embodiment when Number of Optical Inputs and Optical Outputs is Same)

More specifically, FIG. 5 shows an example of a mounting structure in which the number of optical inputs: m₁+n₁ and the number of optical outputs: m₂+n₂ are equal in the wavelength conversion apparatus 500 of the present invention, and one each of signal lights and excitation lights, for example, is performed optical input and output to a single second-order nonlinear optical element.

This is, for example, a configuration in which nonlinear optical elements are mounted in parallel in a structure in which the individual signal light 504 and the individual excitation light 505 are input, wavelength conversion light (idler light) 518 of the individual wavelength is generated, and only the wavelength conversion light (idler light) 518 is extracted, and the wavelength conversion module is useful as a wavelength conversion module having different wavelengths, light intensities, and the like independent from each other.

### (Embodiment When Number of Optical Inputs and Optical Outputs are Different)

FIG. 6 is an example of a mounting structure showing that a plurality of signal light 504 and excitation light 505 are inputted to one second-order nonlinear optical element, and output lights (signal light 512 and excitation light beams 502) are extracted one by one. In this case, the number of optical inputs: m₁+n₁ and the number of optical outputs: m₂+n₂ need not be equal in the wavelength conversion apparatus 600 of the present invention. For example, when the signal light of aforementioned three wavelengths and the excitation light of one wavelength having a strong light intensity are inputted to generate the wavelength conversion light (idler light) 518 of one wavelength and only the wavelength conversion light (idler light) 518 is extracted, the number of light inputs: m₁+n₁=4, and the number of optical outputs: m₂+n₂=2. This is an example of a mounting structure, for example, when a single excitation light with strong light intensity is used to generate difference frequency generation of a plurality of signals from single nonlinear optical element, and so on.

### (Description of Optical Coupling to Wavelength Conversion Element)

As for optical input and output of the wavelength conversion element 514, a lens 506 is used to form a collimated light once, as illustrated in FIG. 5 and FIG. 6, and the optical waveguide core of the wavelength conversion element 514 may be optically coupled by a light reflection mirror or the like by using a spatial optical system composed of a lens. In this case, in order to perform optical multiplexing the signal light 504 and the excitation light 505 as input light and optical coupling to an optical waveguide core 514 b, as shown in FIG. 5 and FIG. 6, for example, it is necessary to perform optical multiplexing by a wavelength selection mirror such as a lens or a multilayer film mirror or a spatial optical system 513 using a dichroic mirror. Similarly, since it is necessary to perform optical demultiplexing the signal light 512 and the excitation light 502 as the output light, an optical system is required for extracting only the output signal light 512 by using an optical band pass filter which is performed optical demultiplexing by a spatial optical system 513 such as a lens or a multilayer film mirror and transmits only a specific optical wavelength band by a multilayer film optical filter.

A wavelength conversion apparatus of the present embodiment comprising: a wavelength conversion element for converting a wavelength of a signal light having an optical waveguide core and a substrate having a lower refractive index for the signal light and the excitation light than the optical waveguide core; and a temperature control element for controlling temperature of the wavelength conversion element, wherein an excitation light of the wavelength of the signal light and n₁ (n₁ being zero and a positive integer) excitation lights that differ from the wavelength of the signal lights are inputted when one or more m₁ (m₁ being a positive integer) signal lights are inputted, an excitation light of the wavelength of the signal light and n₂ (n₂ being zero and a positive integer) excitation lights that differ from the wavelength of the signal lights are inputted when one or more m₂ (m₂ being a positive integer) signal lights are outputted, and in a wavelength conversion apparatus that generates a light of differential frequency wavelength, the signal light and the excitation light are inputted from one side of a housing adjacent to and opposite optical input and output of the wavelength conversion element, and the signal light and the excitation light are outputted from the other side of the opposite housing. According to a structure that is adjacent to the optical input and output of the wavelength conversion element, inputs the signal light and the excitation light to one side of an opposed housing, and provides with the signal light and excitation light outputs on the other side of the opposing enclosure, a space that includes facilities such as a heat source, a light source, and a power supply, is obtained on the end face side other than one side face side of the housing, and is obtain a module structure that makes it easy to mount optical fibers of pigtail by implementation of a wavelength conversion apparatus.

### Second Embodiment

### (Description of Optical Phase Adjustment Mechanism)

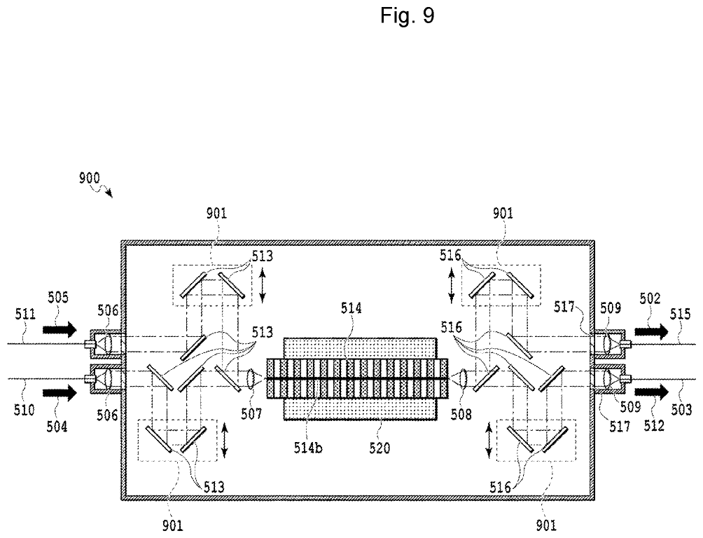

FIGS. 9 to 11 are schematic diagrams of the second embodiment of the present invention.

In the second embodiment of the present invention, as illustrated in the wavelength conversion apparatus 900, the wavelength conversion apparatus 1000 and the wavelength conversion apparatus 1100 of FIGS. 9 to 11, an expansion and contraction mechanism are provided for varying the propagation path distance of the optical input to at least one wavelength conversion element out of each optical input and output of the signal lights 504 and 512 or the excitation lights 505 and 502.

Since the optical signal whose propagation path distance is changed by an expansion/contraction mechanism for varying the propagation path distance is made incident on the wavelength conversion element 514 after time delay or time shortening according to the change of the propagation path distance, as a result, the phase incident on the wavelength conversion element 514 can be finely adjusted.

As the expansion and contraction mechanism of the path length control element 901, which varies the propagation path distance of signal light and excitation light, the position of the light reflection structure combining a plurality of dichroic mirrors and dichroic mirrors of the spatial optical systems 513 and 516 and the retro-reflector such as corner cubes, as shown in FIGS. 9 to 11, is controlled by using a mechanical drive system such as a screw system or rack and pinion system, or a piezoelectric element drive such as lead zirconate titanate (PZT), it is possible to precisely control the light path length by moving it on a single axis with high precision.

### (Embodiment When Number of Optical Inputs and Outputs are Same)

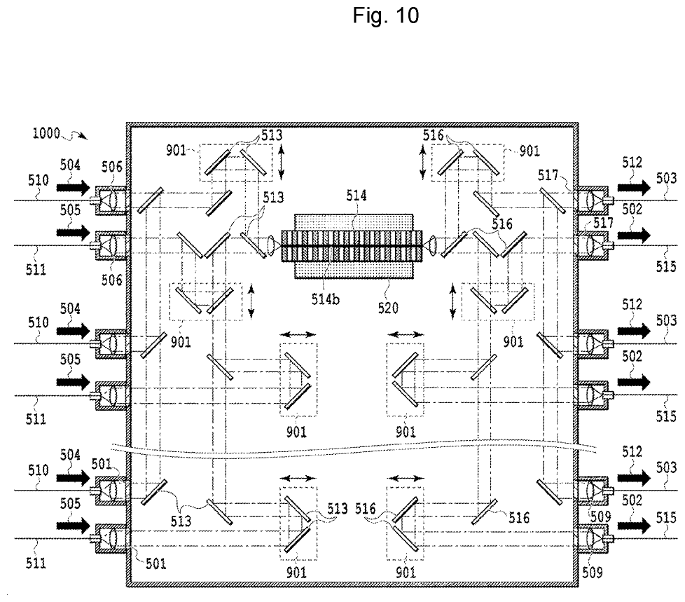

More specifically, in FIGS. 9 and 10, the number of optical inputs: m₁+n₁ and the number of optical outputs: m₂+n₂ have the same configuration, and one second-order nonlinear optical element is provided with, for example, this is an example of a mounting structure with one optical input and output each for signal light and excitation light.

This is a configuration in which nonlinear optical elements are implemented in parallel in a structure that, for example, inputs one individual signal light 504 and one individual excitation light 505 described above, generates wavelength conversion light (idler light) 518 of one individual wavelength, and extracts only the wavelength conversion light (idler light), and this is useful as a wavelength conversion module with independent wavelengths, light intensities, or the like.

### (Embodiment When Number of Optical Inputs and Optical Outputs are Different)

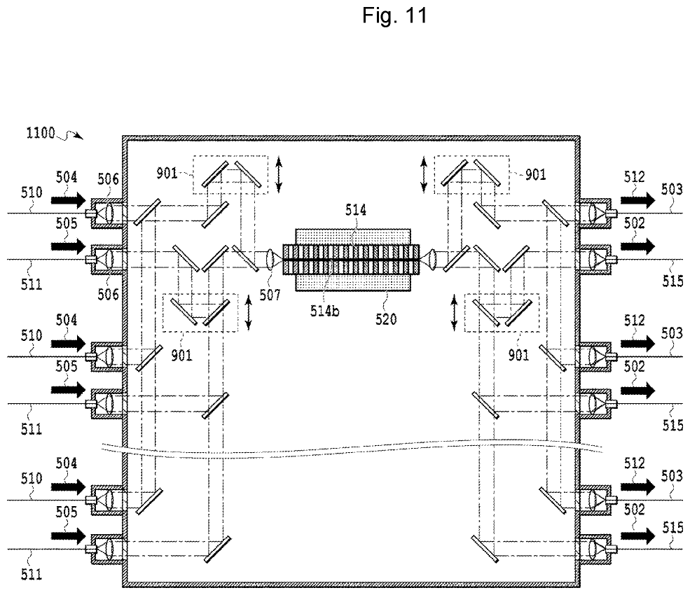

Also, as illustrated in FIG. 11, the number of optical inputs: m₁+n₁ and the number of optical outputs: m₂+n₂ are different configurations for a single second-order nonlinear optical element. For example, this is an example of a mounting structure that inputs multiple signal and excitation lights and extracts one output light each (signal light and excitation light). In the wavelength conversion apparatus 1100, the number of optical inputs: m₁+n₁ and the number of optical outputs: m₂+n₂ need not be equal. For example, if the aforementioned three wavelengths of signal light 504 and one wavelength of excitation light with strong light intensity are input to generate one wavelength of wavelength conversion light (idler light) and then only wavelength-converted light (idler light) is extracted, the number of optical inputs is m₁+n₁=4 and the number of optical outputs is m₂+n₂=2. This is an example of a mounting structure, for example, when a single excitation light with strong light intensity is used to generate difference frequency generation of a plurality of signals from single nonlinear optical element, and so on.

A wavelength conversion apparatus of the present embodiment comprising: a wavelength conversion element for converting a wavelength of a signal light having an optical waveguide core and a substrate having a lower refractive index for the signal light and the excitation light than the optical waveguide core; and a temperature control element for controlling temperature of the wavelength conversion element, wherein an excitation light of the wavelength of the signal light and n₁ (n₁ being zero and a positive integer) excitation lights that differ from the wavelength of the signal lights are inputted when one or more m₁ (m₁ being a positive integer) signal lights are inputted, an excitation light of the wavelength of the signal light and n₂ (n₂ being zero and a positive integer) excitation lights that differ from the wavelength of the signal lights are inputted when one or more m₂ (m₂ being a positive integer) signal lights are outputted, and in the wavelength conversion apparatus that generates light of differential frequency wavelengths, an output that outputs the signal light and the excitation light by inputting the signal light and excitation light is provided, a telescopic mechanism to vary the propagation path distance of light input of the optical input to the wavelength conversion element of at least any one of the respective optical inputs and outputs of the signal light or the excitation light is provided. The feature of the telescopic mechanism to vary the propagation path distance of the optical input to at least one of the wavelength conversion elements from each of the optical inputs and outputs of the signal light or the excitation light enables adjustment of the path distance of the optical signal.

### Modified Example

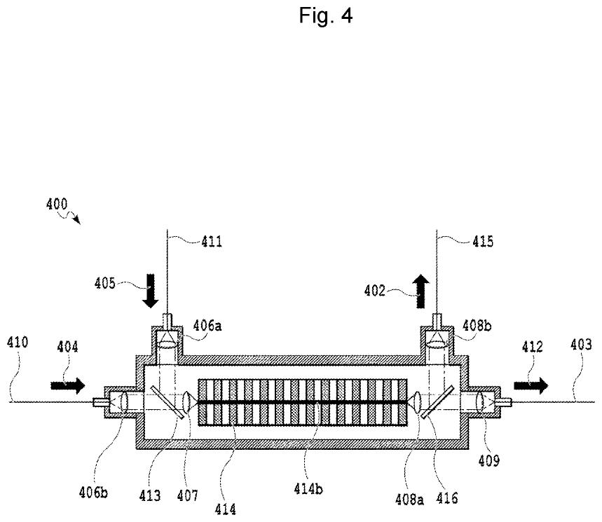

As shown in FIG. 4, the expansion and contraction mechanism as described above can be applied between propagation paths of optical input to at least one wavelength conversion element 514 of the signal light or the excitation light of each optical input and output, to the wavelength conversion apparatus having input and output portions of the excitation light 405 and 402 on the side surface of the housing other than the side surface provided with the input and output portions of the signal light 404 and 412. By this constitution, the effect that the path distance of the optical signal can be adjusted can be obtained.

### Third Embodiment

### (Description of Polarization Separation Wavelength Conversion)

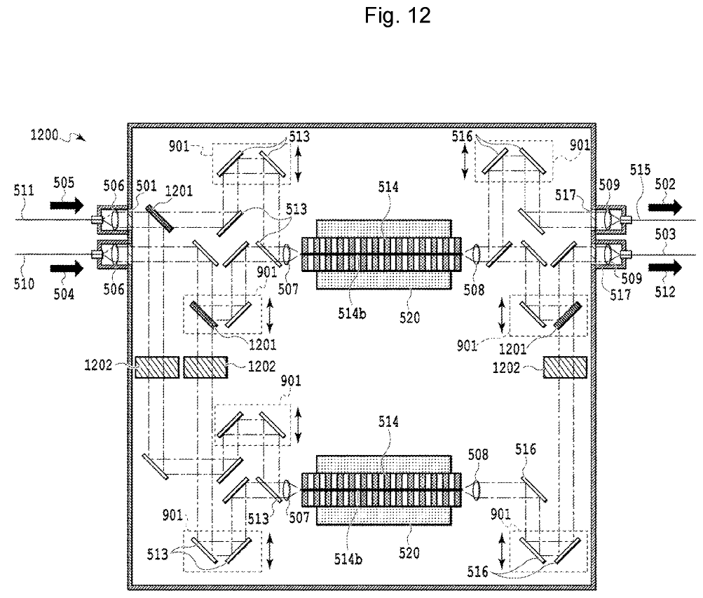

FIGS. 12 to 14 are schematic diagrams of wavelength conversion apparatus 1200, 1300 and 1400 showing a third embodiment of the present invention.

In the third embodiment of the present invention, as illustrated in FIGS. 12 to 14, a polarization separation element 1201 or a polarization rotation element 1202 or both of them are provided between propagation paths of optical input to at least one wavelength conversion element 514 out of optical input and output of signal light or excitation light.

That is, for example, signal light made incident without polarization is separated into TE and TM polarized light by a polarization separation element 1201, For example, in the case of a wavelength conversion element 514 for converting the wavelength of TM polarized light, the TM polarized light is made incident on the wavelength conversion element 514 as it is, The TE polarized light is made incident on a wavelength conversion element 514 by a polarization rotation element 1202, thereby performing wavelength conversion. Thus, wavelength conversion can be performed for all polarized light.

As the polarization separation element 1201, a polarization separation element using a material having birefringence such as calcite, a flat plate-like element using a Brewster window, a cubic element, or a polarization separation element 1201 (polarization beam splitter) having an optical waveguide shape can be used. Further, as the polarization rotation element 1202, a Faraday rotator utilizing a Faraday effect, or a half-wave plate made of an oriented film such as organic and inorganic crystals or a polymer can be used.

### (Embodiment When Number of Optical Inputs and Outputs are Same)

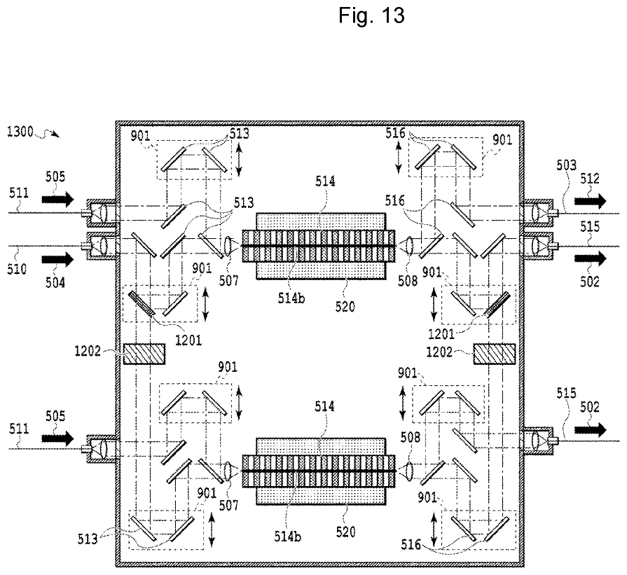

More specifically, in FIGS. 12 and 13, the number of optical inputs: m₁+n₁, and the number of optical outputs: m₂+n₂ have the same configuration.

For example, in the configuration of the wavelength conversion apparatus 1200 illustrated in FIG. 12, the same excitation light 505 is input to one signal light 512 and two fibers for excitation light 511, one signal light 504 and the excitation light 505 are separated by a polarization separation element 1201 for each orthogonal polarization such as TE polarization and TM polarization, and polarization rotation with the polarization rotation element 1202 generates wavelength conversion light (idler light) 518 of one individual wavelength using two similar wavelength conversion elements 514.

Although a secondary optical nonlinear material is used as the wavelength conversion element 514, since the secondary optical nonlinear material itself has anisotropy, even if a similar wavelength conversion element is manufactured, it is difficult to generate equal wavelength conversion light (idler light) for both TE and TM polarization.

The wavelength conversion light (idler light) generated for that purpose is subjected to polarization rotation by a polarization rotation element and is multiplexed again by a polarization separation element to perform wavelength conversion for each orthogonal polarization such as TE polarization and TM polarization to generate wavelength conversion light (idler light) 518 in total polarization, and it can be used as a wavelength conversion module for polarization diversity.

The configuration of the wavelength conversion apparatus 1300 illustrated in FIG. 13 is divided into TE polarization and TM polarization, and when signal light and excitation light are input to two wavelength conversion elements, respectively, when there is a characteristic variation of the wavelength conversion elements, and the control performance is improved when excitation light whose light intensity and light phase are individually controlled is used accordance with each polarization of TE polarization and TM polarization rather than polarization separation of the same excitation light.

(Embodiment when Number of Optical Inputs and Optical Outputs are Different)

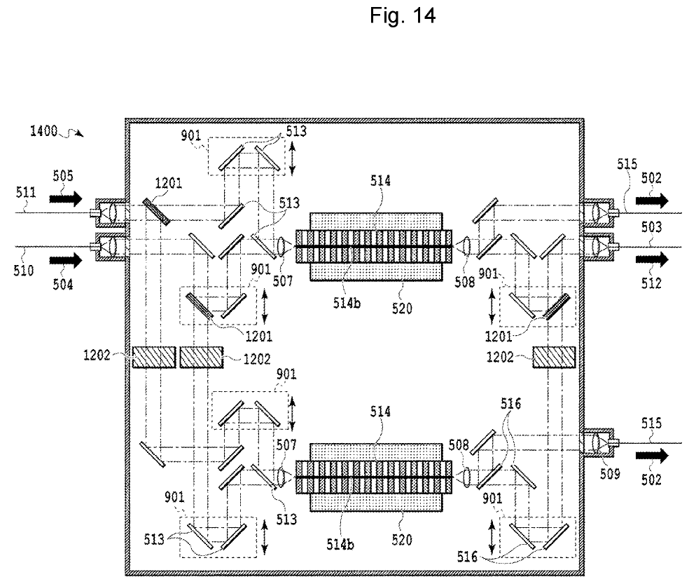

FIG. 14 shows the number of optical inputs: m₁+n₁, and the number of optical outputs: m₂+n₂ is an embodiment of the same configuration.

Similar to FIG. 12, in the configuration example of the wavelength conversion apparatus 1400 shown in FIG. 14, one signal light and the same excitation light are inputted to two excitation optical fibers, and this is the case where one signal light 504 and excitation light 505 are performed TE separation for each orthogonal polarization, the TE polarization and the TM polarization at the polarization separation element 1201, and polarization rotated by polarization rotation element 1202 to generate one individual wavelength of wavelength conversion light (idler light) using two similar wavelength conversion elements 514. However, the wavelength conversion light (idler light) 518 actually generated may vary due to characteristic variations of the wavelength conversion element, so that, for the purpose of indirectly monitoring the wavelength conversion light (idler light) 518, The excitation light emitted from each of the TE polarization waves and the TM polarization waves is output, and the excitation light is observed, and the wavelength conversion light (idler light) in each of the TE polarization waves and the TM polarization waves can be fed back.

A wavelength conversion apparatus of the present embodiment comprising: a wavelength conversion element for converting a wavelength of a signal light having an optical waveguide core and a substrate having a lower refractive index for the signal light and the excitation light than the optical waveguide core; and a temperature control element for controlling temperature of the wavelength conversion element, wherein an excitation light of the wavelength of the signal light and n₁ (n₁ being zero and a positive integer) excitation lights that differ from the wavelength of the signal lights are inputted when one or more m₁ (m₁ being a positive integer) signal lights are inputted, an excitation light of the wavelength of the signal light and n₂ (n₂ being zero and a positive integer) excitation lights that differ from the wavelength of the signal lights are inputted when one or more m₂ (m₂ being a positive integer) signal lights are outputted, and in the wavelength conversion apparatus that generates light of differential frequency wavelengths, an output that outputs the signal light and the excitation light by inputting the signal light and excitation light is provided, and at least one of a polarization separation element and a polarization rotation element is provided on the way of the propagation path of the optical input from each optical input and output of the signal light or the excitation light to at least one of the wavelength conversion elements. The configuration of at least one of a polarization separation element and a polarization rotation element on the way of the propagation paths of the optical input to at least one of the wavelength conversion elements in each optical input and output of the signal light or the excitation light has the effect of enabling highly precise control of the path distance of each individual polarization for polarization diversity control.

### Modified Example

As shown in FIG. 4, at least one of the polarization separation elements 1201 and the polarization rotation element 1202 can be applied between the propagation paths of the optical input to the wavelength conversion element 414 in the wavelength conversion apparatus having the input and output portions of the excitation light 405 and 402 on the side surface of the housing other than the side surface provided with the input and output portions of the signal light 404 and 412. By this constitution, the path distance of each individual polarized wave for polarization diversity control can be controlled with high accuracy.

### Example

### Example 1

The invention is described more specifically by way of examples, but the invention is not limited to these examples.

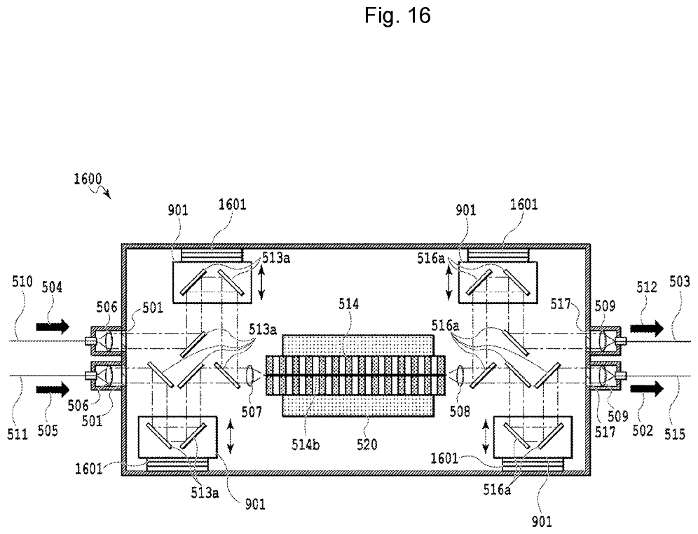

FIG. 16 shows a schematic diagram of the wavelength conversion apparatus 1600 of Example 1 in the present invention. In description, FIG. 8 is also referenced.

For the optical waveguide core 514b in this example, a comb-shaped electrode structure is formed in advance with Au. After that, the optical waveguide core 514b is applied with a high voltage of about 1000 V to form a periodically polarized structure, and the Z-axis of which is perpendicular to the substrate is bonded to the LiNbO₃ substrate on the LiTaO₃ substrate. By the dry etching method with Ar plasma after thin film polishing, a ridge-shaped optical waveguide core 514b is manufactured on the surface of the substrate, the end face is cut by a dicing saw, and a non-reflection coating for the optical wavelength of the signal light and the excitation light was formed on the end face with a metallic multilayer film against the signal light 504 and the excitation light 505, and used as the wavelength conversion element 514.

As described above, the manufactured wavelength conversion element 514 is fixed on the copper support member 523, and at a surface of a metal housing bottom member 522 of a brass module, the metal housing bottom member, the copper support member 523, the metal housing bottom member, a temperature control element 520 comprising a Peltier element is interposed between them, and a silver paste resin bonding member 521 comprising a thermosetting epoxy resin filled with a silver filler is bonded and fixed, for example, by heating and curing at 110° C.

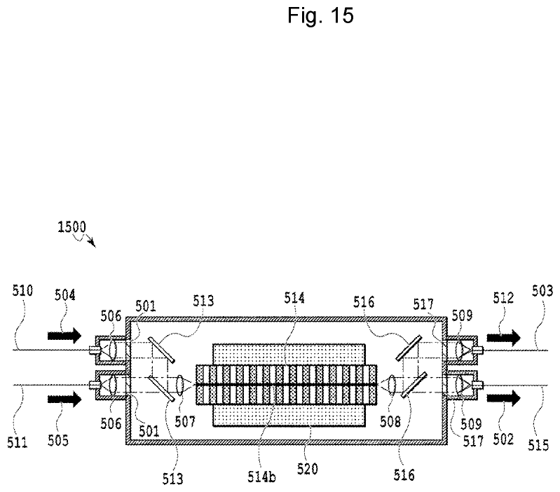

First, using that means, a reference module in configuration mounted on input and output port in which one PANDA optical fiber each corresponding to a signal light with a wavelength of 1560 nm and an excitation light with a wavelength of 780 nm, as shown in FIG. 15, is implemented in the wavelength conversion apparatus 1500 without optical path control mechanism in this example.

Next, a metal housing wider than the basic module is prepared, and an optical path is bent by 90 deg. By using dichroic mirrors 513a and 516a in the middle of optical paths of the signal light 504 and the excitation light 505 as in the wavelength conversion apparatus 1600 of this example shown in FIG. 16, and the following path adjusting mechanism is mounted.

### (Description of Control Mechanism for Optical Path Distance)

A dichroic mirror 513a and a corner cube mirror are bonded and fixed on the path length control element 901 by using thermosetting epoxy so as to reflect the signal light 504 or the excitation light 505.

A PZT piezoelectric element 1601 whose thickness can be controlled by a voltage is laminated on the inner side wall surface of a metal housing by a silver paste resin, wiring connection is performed by a gold thin wire, a path control member having a dichroic mirror and a corner cube mirror adhered and fixed to the surface thereof is aligned at a position where optical coupling is possible to signal light or excitation light, and adhesively fixed.

Thereafter, it was confirmed that the wavelength conversion element reached 55° C. of the intended temperature for use in both the reference module shown in FIG. 15 and the optical module of the present example shown in FIG. 16, and the temperature was adjusted so that the wavelength of the outgoing signal light after the wavelength conversion of the reference module and the module of the present example becomes the same.

The outgoing signal light after wavelength conversion of the reference module and the module in this example was interfered with using an optical coupler of 1:1 of 2×2 of the PANDA fiber, and the light intensity of one of the outgoing lights was measured.

Then, the optical path distance of each signal light and excitation light was varied by changing the voltage value of a PZT piezoelectric element 1601 with a line path control member bonded and fixed which controls the optical path distance of the input signal light 504 and the input excitation light 505. As a result, it was confirmed that the light intensity of the outgoing signal light after optical interference changed periodically with an intensity of more than 30% depending on the voltage, and that the optical path distance could be controlled within a range of more than one wavelength each of the signal lights and excitation lights by the PZT voltage value.

1. A wavelength conversion apparatus comprising:
a wavelength conversion element for converting a wavelength of a signal light having an optical waveguide core and a substrate having a lower refractive index for the signal light and the excitation light than the optical waveguide core; and
a temperature control element for controlling temperature of the wavelength conversion element, wherein
an excitation light of the wavelength of the signal light and n₁ (n₁ being zero and a positive integer) excitation lights that differ from the wavelength of the signal lights are inputted when one or more m₁ (m₁ being a positive integer) signal lights are inputted,
an excitation light of the wavelength of the signal light and n₂ (n₂ being zero and a positive integer) excitation lights that differ from the wavelength of the signal lights are inputted when one or more m₂ (m₂ being a positive integer) signal lights are outputted, and
in a wavelength conversion apparatus that generates a light of differential frequency wavelength, the signal light and the excitation light are inputted from one side of a housing adjacent to and opposite optical input and output of the wavelength conversion element, and the signal light and the excitation light are outputted from the other side of the opposite housing.

2. A wavelength conversion apparatus comprising:
a wavelength conversion element for converting a wavelength of a signal light having an optical waveguide core and a substrate having a lower refractive index for the signal light and the excitation light than the optical waveguide core; and
a temperature control element for controlling temperature of the wavelength conversion element, wherein
an excitation light of the wavelength of the signal light and n₁ (n₁ being zero and a positive integer) excitation lights that differ from the wavelength of the signal lights are inputted when one or more m₁ (m₁ being a positive integer) signal lights are inputted,
an excitation light of the wavelength of the signal light and n₂ (n₂ being zero and a positive integer) excitation lights that differ from the wavelength of the signal lights are inputted when one or more m₂ (m₂ being a positive integer) signal lights are outputted, and
in the wavelength conversion apparatus that generates light of differential frequency wavelengths, an output that outputs the signal light and the excitation light by inputting the signal light and excitation light is provided,
a telescopic mechanism to vary the propagation path distance of light input of the optical input to the wavelength conversion element of at least any one of the respective optical inputs and outputs of the signal light or the excitation light is provided, or
at least any one of a polarization separation element and a polarization rotation element is provided on the way of the propagation path of the optical input to at least one of the wavelength conversion elements.

3. The wavelength conversion apparatus according to claim 2, wherein the wavelength conversion apparatus for generating light of the wavelength of the difference frequency includes an output that outputs the signal light and the excitation light from the other side of a housing facing the side when the signal light and the excitation light are inputted from one side of a housing that is adjacent to the optical input and output of the wavelength conversion element.

4. The wavelength conversion apparatus according to claim 3, wherein the wavelength conversion apparatus includes an input and output unit for the excitation light on a side of the housing other than the side surface.

5. The wavelength conversion apparatus according to claim 1, wherein the signal light and the excitation light have the same number of optical input and output respectively.

6. The wavelength conversion apparatus according to claim 1, wherein an optical fiber is provided for each of the optical inputs and outputs of the signal light or the excitation light.

7. The wavelength conversion apparatus according to claim 1, wherein the optical waveguide core or the substrate contains LiNbO₃ (lithium niobate), KNbO₃ (potassium niobate), LiTaO₃ (lithium tantalate), LiNb(x)Ta(1-x)O₃ (0≤x≤1) (lithium tantalate with indefinite composition), or KTiOPO₄ (potassium titanate phosphate), and at least one selected from Mg (magnesium), Zn (zinc), Sc (scandium), or In (indium) as an additive thereto.

8. The wavelength conversion apparatus according to claim 4, wherein the wavelength conversion apparatus includes one input and output for each of the signal lights and one input and output for each of the excitation lights, and a terminal that is inputted and outputted an electrical signal input from a different side from a side of an opposite housing when the signal light and excitation light are inputted from one side of the opposite housing adjacent to the optical input and output of the wavelength conversion element, and the signal light and excitation light are outputted from the other side of the opposite housing.

9. The wavelength conversion apparatus according to claim 2, wherein the signal light and the excitation light have the same number of optical input and output respectively.

10. The wavelength conversion apparatus according to claim 2, wherein an optical fiber is provided for each of the optical inputs and outputs of the signal light or the excitation light.

11. The wavelength conversion apparatus according claim 2, wherein the optical waveguide core or the substrate contains LiNbO₃ (lithium niobate), KNbO₃ (potassium niobate), LiTaO₃ (lithium tantalate), LiNb(x)Ta(1−x)O₃ (0≤x≤1) (lithium tantalate with indefinite composition), or KTiOPO₄ (potassium titanate phosphate), and at least one selected from Mg (magnesium), Zn (zinc), Sc (scandium), or In (indium) as an additive thereto.
